(19) United States
(12) Patent Application Publication
(10) Pub. No.: US 2007/0082693 A1
(43) Pub. Date: Apr. 12, 2007

(54) Communication apparatus having foldable and turnable housing members

(75) Inventors: Mikkel Drucker, Copenhagen V (DK); Jacob Jensen, Frederiksberg C (DK); Niels Peter Emme, Copenhagen S (DK); Robert Pitt, Surrey (GB)

Correspondence Address: BANNER & WITCOFF, 1001 G STREET N W, SUITE 1100, WASHINGTON, DC, 20001, US

(73) Assignee: NOKIA CORPORATION, ESPOO (FI)

(21) Appl. No.: 10/579,788

(22) PCT Filed: Nov. 20, 2003
(86) PCT No.: PCT/IB03/05269

§ 371 Date: May 18, 2006

(51) Int. Cl. H04M 1/00

(52) U.S. Cl. 455/550.1

(57) ABSTRACT

A communication apparatus has a first housing member (100) and a second housing member (200), which are mechanically interconnected so that said first housing member is foldable as well as turnable with respect to said second housing member so as to assume different operating positions. The communication apparatus has a user interface (334) including a display (110) and manual input means (120, 220), and a processing device (300) for providing services (340-346) to a user through said user interface, wherein said display is located in said first housing member. The manual input means comprises a first set of keys (120) comprised in said first housing member (100), and a second set of keys (220) comprised in said second housing member (200), wherein a plurality of said services (340-346) are controllable by said user through said first set of keys.

### FIELD OF THE INVENTION

The present invention relates to the field of mobile telecommunications. More specifically, the present invention relates to a communication apparatus comprising a first housing member and a second housing member, which are mechanically interconnected so that said first housing member is foldable as well as turnable with respect to said second housing member.

### BACKGROUND OF THE INVENTION

A common example of a communication apparatus according to the above is a mobile terminal for an existing mobile telecommunication system such as GSM, D-AMPS, CDMA2000 or UMTS. Traditionally, the design of mobile terminals have often been based on a single apparatus housing member, which contains all components of the mobile terminal, including display, keypad, antenna, microphone, speaker, battery and various electronic circuitry. Such a design is often referred to as “monoblock”.

One trend in the field of mobile terminals is miniaturization, in the sense that the physical size and weight of mobile terminals have been continuously reduced since mobile terminals emerged some decades ago. Another trend is increased and broadened functionality of mobile terminals, which no longer are merely a tool for speech communication between two individuals, but in addition provide services such as messaging (SMS, email, MMS), calendar, phonebook, still and video imaging (camera), internet browsing (WAP, WWW), video games, etc.

In line with the above trends, many models of mobile terminals are known which are foldable, i.e. one housing member is pivotally hinged to another housing member, so that the mobile terminal may be folded into a closed position in periods of inactivity, wherein the display and/or keypad will be protected and the mobile terminal will occupy a small physical space, and so that the mobile terminal may be unfolded into an open position adapted for active use, wherein the display and keypad are accessible to the user. U.S. Pat. No. 5,923,751 discloses an example of a foldable mobile terminal according to the prior art. In addition, mobile terminals are known, where two housing members are turnably interconnected rather than foldably, but the overall principle of which is similar to foldable mobile terminals. One example of such a mobile terminal is given in U.S. Pat. No. 5,485,517.

More recently, mobile terminals with built-in camera capabilities have become popular. The camera of such mobile terminals may provide image and/or video recording capabilities to a user. Even more recently, camcorder-type mobile terminals have been introduced, having first and second housing members which are not only foldably interconnected but also turnably through a biaxial hinge assembly which couples the first housing member to the second housing member. Typically, the first housing member comprises a large display, whereas the second housing member comprises a keypad containing conventional telephone keys such as 0 through 9, *, #, answer/yes, hang-up/no and clear, as well as additional keys for controlling a graphical user interface, such as arrow keys, four/five-way navigation keys, soft keys, etc. A camera lens is normally located either in the second housing member or in the biaxial hinge. Thanks to the biaxial hinge arrangement, the user may use the mobile terminal as an ordinary foldable terminal (“flip telephone”) for speech communication, messaging, internet browsing, etc, and then turn the first housing member (with its display) into a convenient angular position with respect to the second housing member when using the mobile terminal for recording images or video. The user may also close the mobile terminal by folding together the first and second housing members for convenient storage during periods of inactivity.

Some known foldable and turnable mobile terminals allow the terminal to be folded into a closed position with the display not folded inwardly, as would be the case for a traditional foldable terminal, but outwardly, so that the display is visible also when the terminal assumes its closed/folded position. In this way, the user is given an opportunity to monitor the mobile terminal, for instance to read the current date or time, the current battery charge level, a notification of an incoming message or the telephone number of an incoming call (or even the name of a caller associated with such a telephone number, if existing in the phonebook). However, in order to use the majority of the services that are provided by the mobile terminal, the user will have to unfold/open the terminal, so that the keypad-carrying housing member is turned into a position where the keypad is accessible. Hence, if the user wants to initiate an outgoing telephone call, start an internet browsing session, write a new outgoing message, play a video game, access the calendar, etc, he or she can not do this without first performing such opening/unfolding/turning actions. Such a mandatory step of manual intervention is regarded inconvenient by many users.

### SUMMARY OF THE INVENTION

In view of the above, an objective of the invention is to solve or at least reduce the problems discussed above. In particular, an objective is to provide a foldable and turnable communication apparatus (e.g. a mobile terminal), which offers great flexibility to the user when it comes to choosing different operating positions—by pivoting the first and second housing members with respect to each other—and using the services or applications of the communication apparatus in many of these operating positions. In more particular, an objective is to provide a communication apparatus, which may be used in various unfolded/opened and turned operating positions but also in a folded, compact position, specifically so that a plurality of the services are accessible to the user also in the folded, compact position.

Generally, the above objectives are achieved by a communication apparatus according to the attached independent patent claims.

A first aspect of the invention is a communication apparatus comprising a first housing member and a second housing member, which are mechanically interconnected so that said first housing member is foldable as well as turnable with respect to said second housing member so as to assume different operating positions, said communication apparatus having a user interface including a display and manual input means, and a processing device for providing services to a user through said user interface, wherein said display is located in said first housing member. The manual input means comprises a first set of keys comprised in said first housing member, and a second set of keys comprised in said second housing member, wherein a plurality of said services are controllable by said user through said first set of keys.

An advantage with such a communication apparatus is that the user can decide whether to use the communication apparatus in a folded, compact position or in any of a plurality of expanded (unfolded and/or turned) positions at any particular moment. Thanks to the provision of the first set of keys on the same housing member (the first housing member) as the display, the communication apparatus may be used for said plurality of services also in the compact position.

Advantageously, the communication apparatus is a mobile terminal for a mobile telecommunication system such as GSM, D-AMPS, CDMA2000 or UMTS. Thus, a telephone application for performing speech communication in the form of telephone calls may be included in said plurality of said services. Even more advantageously, said plurality of said services comprises at least two services selected from the following group:

a telephone application for performing speech communication in the form of telephone calls,

an Internet browser application,

a WWW browser application,

a WAP browser application,

a phonebook application,

a contacts application,

a camera application,

an image recording application,

a video recording application,

a messaging application,

an email application,

an SMS application,

an MMS application,

a calendar application,

an organizer application,

a video game application,

a calculator application,

a voice memo application,

an alarm clock application,

a word processing application,

a code memory application,

a music player application,

a media streaming application, and

a control panel application.

The operating positions may include a compact position in which said first housing member is folded against said second housing member, wherein said first set of keys and said display are accessible to, and said plurality of said services are controllable by, said user in said compact position.

Advantageously, said first set of keys and said display are arranged in essentially the same plane. Said same plane may coincide with or be parallel to a front side of said first housing member.

The operating positions may also include an open position in which said first housing member is unfolded from said second housing member, wherein said first set of keys and said display as well as said second set of keys are accessible to, and said plurality of said services are controllable by, said user in said open position.

The communication apparatus advantageously comprises a camera, wherein said operating positions may include a camcorder position in which said first housing member is unfolded as well as turned with respect to said second housing member, and wherein said first set of keys and said display are accessible to, and a camera application among said services is controllable by, said user in said camcorder position. In addition, the operating positions may include a self-portrait position in which said first housing member is unfolded with respect to said second housing member and turned by substantially 180° with respect to said camcorder position, wherein said first set of keys and said display are accessible to, and the camera application is controllable by, said user in said self-portrait position.

The first set of keys advantageously comprises at least one context-sensitive key, the function of which depends on an active one of said plurality of said services that currently is controlled through said user interface. The first set of keys may comprise at least one navigation key for multi-directional navigating and selecting actions in said user interface.

The second set of keys may include a group of keys that constitutes a telephone-type (PIN, IT-U) keypad and includes digit keys 0 through 9.

A second aspect of the invention is a communication apparatus comprising a first housing member, a second housing member and a hinge assembly having a first hinge functionality connecting the first and second housing members pivotally to each other, and a second hinge functionality allowing one of said first and second housing members to turn relatively to the other housing member. Said first housing member comprises a display and a set of keys for operating the communication apparatus, and said hinge assembly allows said first and second housing members to assume first and second closed positions. In said first closed position, said display and said set of keys of said first housing member face towards said second housing member, whereas, in said second closed position, said display and said set of keys of said first housing member are exposed and allow a user to operate said communication apparatus.

A plurality of services provided by said communication apparatus may be controllable through said set of keys in said second closed position. Said plurality of services may include speech communication in the form of telephone calls.

Said set of keys may comprise at least one context-sensitive key, the function of which depends on an active one of said plurality of services. Said set of keys may moreover comprise at least one navigation key for multi-directional navigating and selecting actions in an active one of said plurality of services.

The communication apparatus according to the second aspect may be a mobile terminal for a mobile telecommunication system such as GSM, D-AMPS, CDMA2000 or UMTS.

The second aspect of the invention has generally the same objectives, features and advantages as the first aspect of the invention. Other objectives, features and advantages of the present invention will appear from the following detailed disclosure, from the attached dependent claims as well as from the drawings.

### BRIEF DESCRIPTION OF THR DRAWINGS

A preferred embodiment of the present invention will now be described in more detail, reference being made to the enclosed drawings, in which:

FIG. 1a and 1b illustrate a mobile terminal according to the preferred embodiment in a closed position, with first and second housing members folded against each other and with the display facing inwardly, suitable particularly for periods of inactivity,

FIG. 2a and 2b illustrate the mobile terminal in a compact/folded position, in which the first and second housing members are folded against each other, but where the first housing member has been turned by 180° compared to FIG. 1a and 1b and the display instead faces outwardly,

FIG. 2c is a schematic front view of the display and a first set of keys, which are all accessible to the user in the position illustrated in FIG. 2a and 2b,

FIG. 3a and 3b illustrates the mobile terminal in an open/unfolded position, where not only the display and the first set of keys from FIG. 2a-2c are accessible, but also a second set of keys,

FIG. 3c is a schematic front view of the second set of keys shown in FIG. 3a and 3b,

FIG. 4a and 4b show the mobile terminal in a camcorder position, where the first housing member is not only unfolded/opened with respect to the second housing member, but also turned into a position convenient for recording of images or video,

FIG. 5a and 5b show the mobile terminal in a self-portrait position similar to the one shown in FIG. 4a and 4b, where however the first housing member has been turned by 180° compared to FIG. 4a and 4b, so that the mobile terminal in this position may be conveniently used for recording of self-portrait video or images, and

FIG. 6 is a schematic diagram of the hardware and software structure of the mobile terminal.

### DETAILED DISCLOSURE OF THE INVENTION

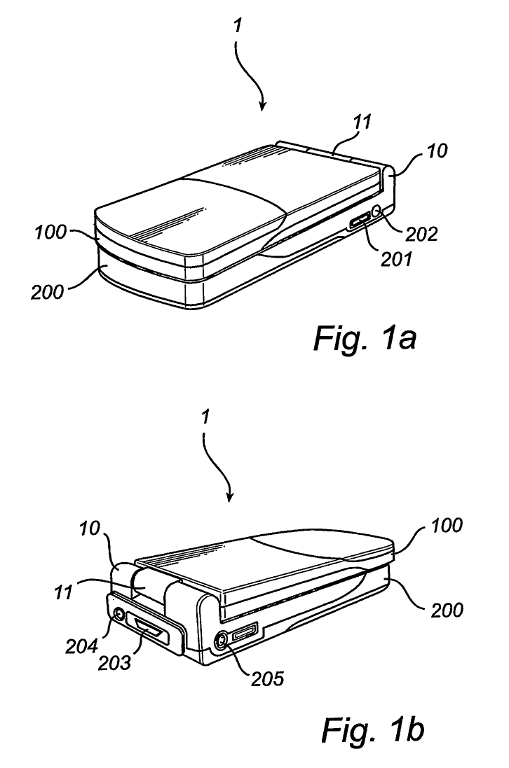

As seen in FIG. 1a/1b-5a/5b the mobile terminal 1 according to the preferred embodiment comprises a first housing member 100 and a second housing member 200. The first and second housing members 100, 200 are inter-connected through a biaxial hinge assembly 10, 11, so that the first and second housing members may be pivoted with respect to each other about a first axis, which essentially coincides with the longitudinal extension of the hinge 10, and about a second axis, which is perpendicular to the first axis and which essentially coincides with the longitudinal center axis of the first housing member 100 through a center portion 11 of the hinge assembly. Thanks to this arrangement, the mobile terminal 1 may assume different operating positions, in which the first and second housing members 100, 200 are folded and/or turned with respect to each other.

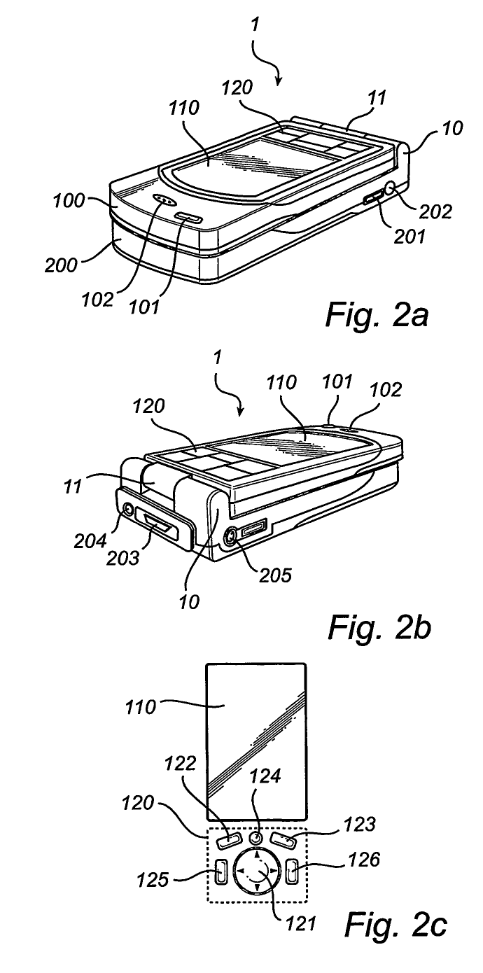

As seen in the drawings, the mobile terminal 1 comprises a display 110, which is located at a front side 100a of the fist housing member 100. The display 110 is advantageously a high-resolution color LCD display. Below the display 110, at said front side of the first housing member 100, a first set of keys (keypad) 120 is provided. As seen more clearly in FIG. 2c, the first set of keys 120 comprises a five-way navigation key 121, by way of which the user may navigate in four different directions in a user interface presented on the display 110 as well as perform selecting operations by depressing the center portion and/or peripheral rim portion of the navigation key 121.

The first set of keys 120 also comprises left and right function keys or soft keys 122, 123, which in a manner known per se will perform various functions presented at the bottom of the display 110 in the application or service which is currently active and in control of the display 110. For instance, in the main menu screen of a messaging application, the left function key 122 may represent Options that are available, whereas the right function key 122 may represent Exit from the messaging application. The display 110 will present the text “Options” at the lower left corner, just above the key 122, and the text “Exit” will be presented at the lower right corner, just above the key 123. If the Options alternative is chosen by depressing key 122, a list of options may be presented on the display 120, for instance Create new SMS, Create new MMS, Create new email, Settings and Help. When this list is presented, the functions of keys 122 and 123 may change to Select and Cancel. If any of the options thus presented is selected, the functions of keys 122 and 123 may change again.

A clear key 124 serves to command actions such as backspace, escape etc. An application key 125 allows the user to toggle between applications and items in a menu-based main application menu. An alpha key 126 is used in some applications for changing dictionaries and performing multiple selection actions.

The first housing member 100 also has an on/off key 101 and a speaker 102.

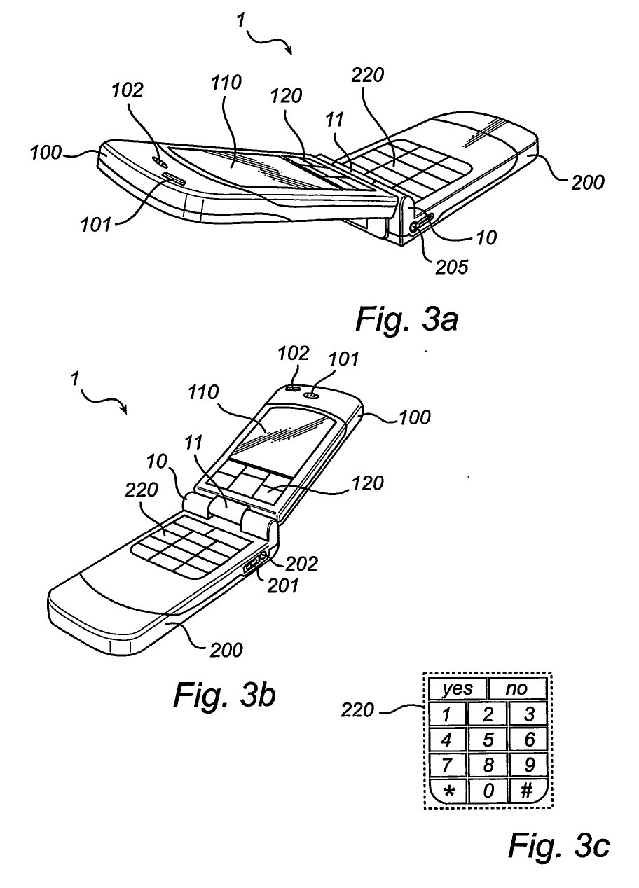

The second housing member 200 is provided with a second set of keys (keypad) 220 at a front side 200a. As seen more clearly in FIG. 3c, the second set of keys 220 comprises a collection of keys which are particularly suited for manual dialing, including an answer/yes key, a hang-up/no key, digit keys 0 through 9, and * and #. A first lateral side of the second housing member 200 comprises volume up and down keys 201 as well as a push-to-talk key 202, by way of which the mobile terminal 1 may be used for walkie-talkie-type communication directly with another mobile terminal without using any intermediate stations in the mobile telecommunications network.

At an opposite lateral side of the second housing member, the lens of a camera 205 is provided. The camera 205 is capable of digital image and/or video recording and comprises suitable optical and electronic components, including a CMOS sensor or a CCD sensor. A bottom side of the second housing member 200 has an accessory terminal 203 and a charging terminal 204. A battery lid 206 is provided at a rear side 200b of the second housing member.

FIG. 3 illustrates the internal structure of the mobile terminal 1. A controller 300 is responsible for the overall operation of the mobile terminal and is preferably implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data and program instructions for various software in the mobile terminal. The software includes a real-time operating system 320, a man-machine interface (MMI) 334 that provides a graphical, menu-based user interface, an application handler 332 as well as various applications that provide different respective services to the user. The applications include an Internet (WWW, WAP) browser 340, a phonebook (contacts) application 342, a camera/image application 344 and a messaging (email, SMS, MMS) application 346, as well as various other applications such as calendar/organizer, video games, calculator, etc, which are not referred to in detail herein. Needless to say, the applications also include a telephone application for performing speech communication in the form of telephone calls to users of other mobile terminals or terminals in a private or public switched telephone network. The telephone application may either be integrated with the phonebook application 342 or a separate application.

The MMI 334 cooperates, through I/O drivers 305, with a plurality of input/output (I/O) devices, including the display 110 and the first and second sets of keys (keypads) 120 and 220 as well as various other I/O devices such as camera 205, microphone/speaker 303 (102), LED call indicator, a vibrator, a ringtone/call alert signal generator, etc. As is commonly known, a user may operate the mobile terminal 1 and control its various application through the man-machine interface 334 thus formed.

The software also includes various modules, protocol stacks, drivers, etc., which are commonly designated as 330 and which provide communication services (such as transport, network and connectivity) for an RF interface 306 and, optionally, a Bluetooth interface 308 and an IrDA interface 310. The RF interface 306 comprises an internal or external antenna as well as appropriate radio circuitry for establishing and maintaining a wireless link to a base station in a mobile telecommunications system. As is well known to a man skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

A battery 301 is provided behind the battery lid 206. The mobile terminal 1 also has a SIM card 304 and an associated reader. As is commonly known, the SIM card 304 comprises a processor as well as local work and data memory.

The different operating positions of the mobile terminal 1 will now be explained in more detail.

Closed Position

A first operating position is a closed position, which is shown in FIG. 1a-b and in which the first and second housing members are folded against each other into a closed position. The closed position is particularly suitable for periods of inactivity, since this position occupies little physical space and protects the display 110 and keypads 120/220 from external forces. In the closed position, the display 110 is turned off so as to preserve power. Moreover, in order to save additional power, some of the internal components of the mobile terminal 1 may be turned off or forced into a low-power mode. Conveniently, such power saving may be performed for the controller 300, memory 302, RF components 306, Bluetooth components 308, IRDA components 310, and camera components 205. In the closed position, if the mobile terminal 1 is left turned on, it will of course be receptive of incoming telephone calls, which may be indicated visually by a LED call indicator as well as acoustically by way of a call alert signal (ring signal, melody, etc) as is well known in the art. A long press on volume down key 201 may silence the call alert signal for an incoming call. Moreover, accessories may be connected to the mobile terminal 1 in the closed position by way of the accessory connector 203. The mobile terminal 1 may be charged through the charging terminal 204.

Compact Position

A second operating position is a compact position, which is shown in FIG. 2a-b. As in FIG. 1a-b, the first and second housing members 100, 200 are folded against each other, but here the first housing member 100 has been turned by 180° compared to its position in the closed position. The front side 100a faces outwardly, and the user will have full access to the display 110 as well as the first set of keys 120. Thus, even though the compact position occupies as little physical space as the closed position, the services 340-346 of the mobile terminal will be accessible to the user, even if the second set of keys 220 is not accessible as shown in FIG. 2a-b, thanks to the provision of the first set of keys 120 beneath the display 110 at the front side 100a. Particularly the function keys 122, 123, which are dynamically assigned useful functions depending on the currently active application or sub-routine in that application, and the navigation key 121, which allows multi-directional navigating and selecting actions in the man-machine interface 334, will offer the user complete access and control of the services 340-346.

For instance, the user may browse the Internet by way of the Internet browser 340, read and write messages by way of the messaging application 346, or generate an outgoing telephone call by way of the phonebook application 342 or a separate telephone application, as the case may be—optionally by way of voice activated dialing rather than manual input. The user may also receive and answer incoming telephone calls, preferably by pressing the left function key 122 which will be assigned an Answer function upon detection of an incoming call. The user may also record images or video by way of the camera/image application 344.

Open Position

A third operating position is an open (unfolded) position, which is shown in FIG. 3a-b. Here, the first and second housing members 100, 200 are unfolded from each other into a position which is similar to the normal operating position of a foldable (flip) terminal. Thus, in this position both the first and the second set of keys 120, 220 are accessible to the user. All services that are available in the compact position are available also in the open position, and in addition the user may make beneficial use of also the second set of keys 220. For instance, these keys may facilitate input of numbers in the telephone application (when dialing a new telephone number) or calculator application, or facilitate input of text in the messaging application or a word processing application, or serve as control keys in video game applications. Moreover, the answer/yes and hang-up/no keys may be conveniently used for initiating, ending and rejecting a telephone call.

When the user switches the terminal 1 into its open position (from e.g. the compact position or closed position), the terminal may be adapted to automatically change profiles in the man-machine interface 334 (e.g. change call alert signals, display background pattern/-color), turn on the display, automatically answer to an incoming call, etc. Similar actions may be performed when the terminal 1 is switched from its open position.

Camcorder Position

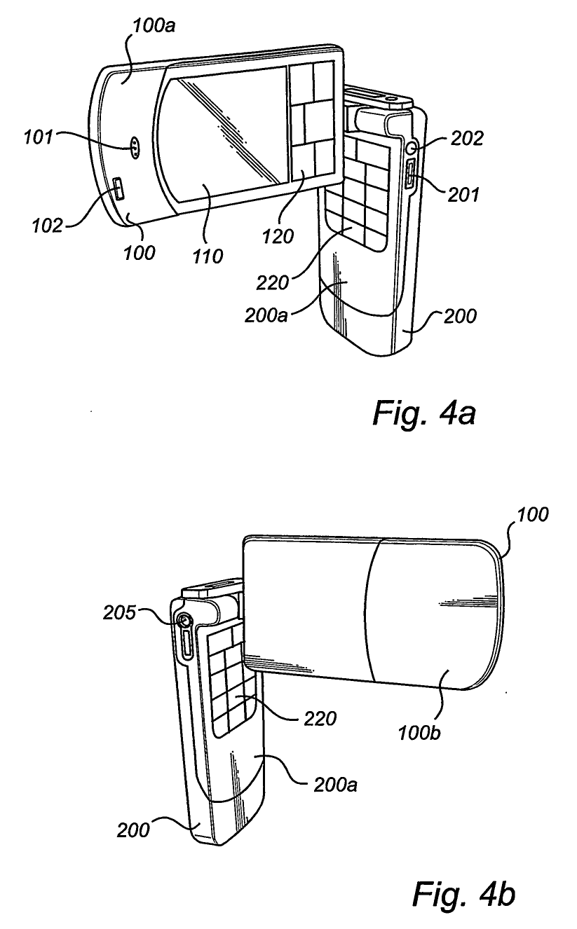

A fourth operating position is a camcorder position, which is shown in FIG. 4a-b. Here, the first and second housing members 100, 200 are unfolded from each other by about 90°. In addition, the first housing member 100 is turned with respect to the second housing member (200) by about 90° compared to its location in the open position. Both the first set of keys 120 and the second set of keys 220 are accessible and may be used depending on application.

The camcorder position is particularly useful for the camera/image application 344 and will allow the user to record images or video while conveniently using the display as a recording monitor. As seen in FIG. 4a-b, the display 110 faces in one direction, towards the user, whereas the camera 205 faces in the opposite direction, away from the user and towards a target object to be recorded. The volume up and down keys 201 at the lateral side of the second housing member 200 may be used for zooming in and out (digital and/or optical zoom depending on the capabilities of the camera 205) during image or video recording. The push-to-talk key 202 may be used to start and stop recording. Moreover, also the first set of keys 120 may be used in the camera/image application 344. For instance, the navigation key 121 may be used to pan or scroll in a recorded image, e.g. when the image is magnified and not all parts thereof can be shown within the display at the same time, or for selecting various settings options related to image or video recording and processing (resolution, color depth, brightness, saturation, etc). The function keys 122, 123 may for instance represent actions that are commonly used in the camera/image application 344.

The mobile terminal 1 may be adapted to automatically start the camera/image application 344 when the camcorder position is entered.

Self-Portrait Position

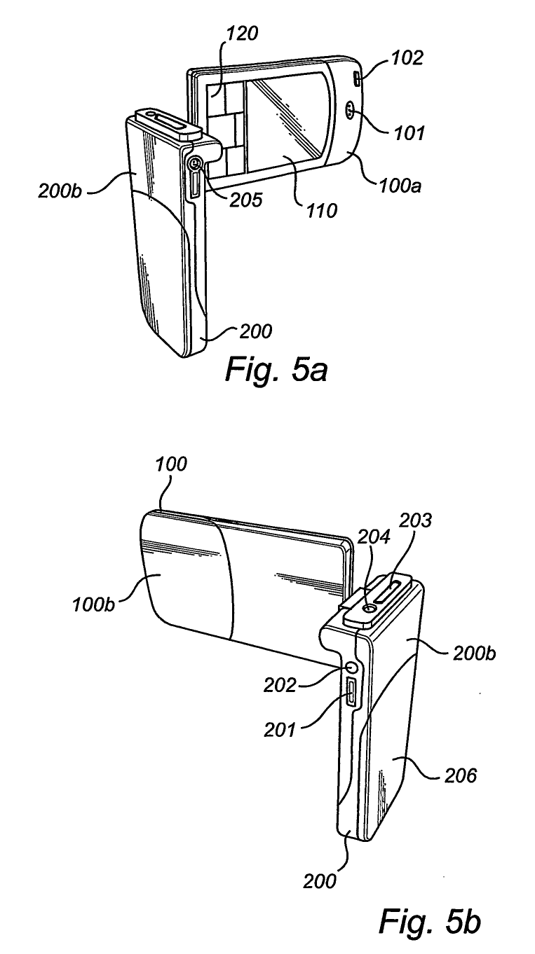

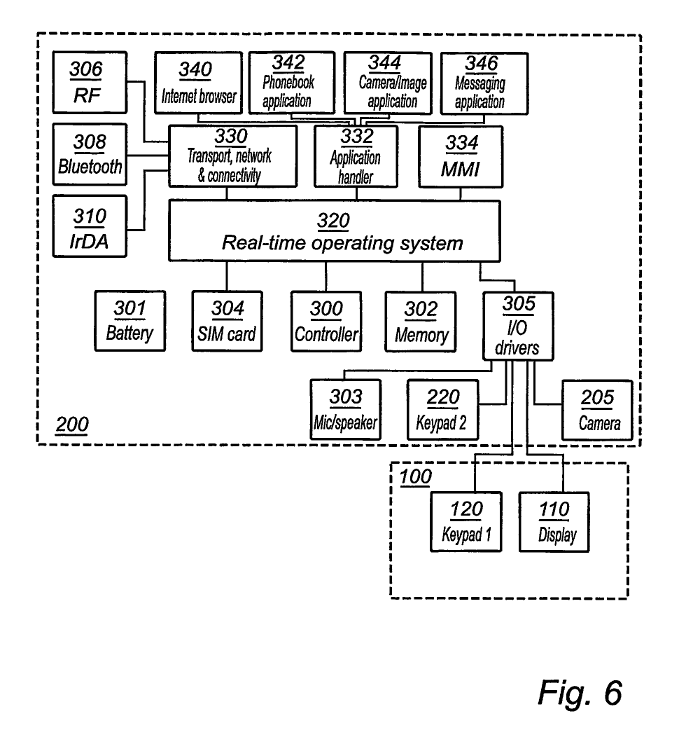

A fifth operating position is a self-portrait position, which is shown in FIG. 5a-b. Here, the first and second housing members 100, 200 are unfolded from each other as in the camcorder position. Here, however, the first housing member 100 is turned with respect to its location in the camcorder position by about 180°. Thus, in contrast to FIG. 4a-b, the display 110 and the camera 205 now face in the same direction, towards the user. Thus, the position illustrated in FIG. 5a-b is particularly suitable for recording of a self-portrait (still image) or, even, a video of the user captured by himself/herself.

The keys 201, 202 and first set of keys 120 may be used in a similar way as in the camcorder position.

The mobile terminal 1 may be adapted, upon transition from the camcorder position to the self-portrait position, or vice versa, to automatically flip the image presented on the display 110 vertically (upside down) and also horizontally, so as to render the displayed image intuitive to the user.

The invention has mainly been described above with reference to a preferred embodiment. However, as is readily appreciated by a person skilled in the art, other embodiments than the one disclosed above are equally possible within the scope of the invention, as defined by the appended patent claims. For instance, the exact angles between the first and second housing members 100, 200 in the different operating positions are not critical and are not limited to the angles shown in the drawings. Moreover, the first housing member may be turnable with respect to the second housing member in less than one full turn (i.e, <360°) or in at least one full turn (i.e, >=360°), in different embodiments.

In some embodiments, particularly ones that have a camera arrangement other than the one shown in the preferred embodiment, the compact position and/or open position may be used for camcorder and/or self-portrait functionality.

1. A communication apparatus comprising a first housing member and a second housing member, which are mechanically interconnected so that said first housing member is foldable as well as turnable with respect to said second housing member so as to assume different operating positions, said communication apparatus having a user interface including a display and manual input means, and a processing device for providing services to a user through said user interface, wherein said display is located in said first housing member, in that wherein said manual input means comprises a first set of keys comprised in said first housing member and a second set of keys comprised in said second housing member, wherein a plurality of said services are controllable by said user through said first set of keys,
said operating positions including a compact position in which said first housing member is folded against said second housing member, wherein said first set of keys and said display are accessible to, and said plurality of said services are controllable by, said user in said compact position, and
said operating positions including an open position in which said first housing member is unfolded from said second housing member, wherein said first set of keys and said display as well as said second set of keys are accessible to, and said plurality of said services are controllable by, said user in said open position.

2. A communication apparatus according to claim 1, wherein said first set of keys and said display are arranged in essentially the same plane.

3. A communication apparatus according to claim 2, wherein said same plane coincides with or is parallel to a front side of said first housing member.

4. A communication apparatus according to claim 1, wherein a telephone application for performing speech communication in the form of telephone calls is included in said plurality of said services.

5. A communication apparatus according to claim 1, wherein said plurality of said services comprises at least two services selected from the following group:
a telephone application for performing speech communication in the form of telephone calls,
an Internet browser application,
a WWW browser application,
a WAP browser application,
a phonebook application,
a contacts application,
a camera application,
an image recordal application,
a video recordal application,
a messaging application,
an email application,
an SMS application,
an MMS application,
a calendar application,
an organizer application,
a video game application,
a calculator application,
a voice memo application,
an alarm clock application,
a word processing application,
a code memory application,
a music player application,
a media streaming application, and
a control panel application.

6. A communication apparatus according to claim 1, further comprising a camera, said operating positions including a camcorder position in which said first housing member is unfolded as well as turned with respect to said second housing member, wherein said first set of keys and said display are accessible to, and a camera application among said services is controllable by, said user in said camcorder position.

7. A communication apparatus according to claim 6, said operating positions including a self-portrait position in which said first housing member is unfolded with respect to said second housing member and turned by substantially 180° with respect to said camcorder position, wherein said first set of keys and said display are accessible to, and a camera application among said services is controllable by, said user in said self-portrait position.

8. A communication apparatus according to claim 1, wherein said first set of keys comprises at least one context-sensitive key, the function of which depends on an active one of said plurality of said services, that currently is controlled through said user interface.

9. A communication apparatus according to claim 1, wherein said first set of keys comprises at least one navigation key for multi-directional navigating and selecting actions in said user interface.

10. A communication apparatus according to claim 1, wherein said second set of keys includes a group of keys that constitutes a telephone-type keypad and includes digit keys 0 through 9.

11. A communication apparatus according to claim 1, in the form of a mobile terminal for a mobile telecommunication system.

12. A communication apparatus comprising a first housing member, a second housing member and a hinge assembly having a first hinge functionality connecting the first and second housing members pivotally to each other, and a second hinge functionality allowing one of said first and second housing members to turn relatively to the other housing member,
wherein said first housing member comprises a display and a set of keys for operating the communication apparatus, and in that said hinge assembly allows said first and second housing members to assume first and second closed positions in which said first and second housing members are folded against each other, as well as an open position in which said first and second housing members are unfolded from each other,
wherein, in said first closed position, said display and said set of keys of said first housing member face towards said second housing member, and
wherein, in said second closed position as well as in said open position, said display and said set of keys of said first housing member are exposed and allow a user to operate said communication apparatus.

13. A communication apparatus according to claim 12, wherein a plurality of services provided by said communication apparatus are controllable through said set of keys in said second closed position.

14. A communication apparatus according to claim 13, wherein said plurality of services includes speech communication in the form of telephone calls.

15. A communication apparatus according to claim 13, wherein said set of keys comprises at least one context-sensitive key, the function of which depends on an active one of said plurality of services.

16. A communication apparatus according to claim 13, wherein said set of keys comprises at least one navigation key for multi-directional navigating and selecting actions in an active one of said plurality of services.

17. A communication apparatus according to claim 12, in the form of a mobile terminal for a mobile telecommunication system.
